(19) United States
(12) Patent Application Publication
(10) Pub. No.: US 2010/0169877 A1
(43) Pub. Date: Jul. 1, 2010

(54) Method Of Updating A Printing Device Via Syndication Services

(76) Inventors: Erik Nils Ackerman, Lexington, KY (US); David Zachery Lindsey, JR., Paris, KY (US); Samuel Leo Rhodus, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/346,031

(22) Filed: Dec. 30, 2008

(51) Int. Cl. G06F 9/44; G06F 3/12

(52) U.S. Cl. 717/171; 358/1.15

(57) ABSTRACT

It is a first aspect of the present invention to provide a computer implemented method of updating a device via syndication services that includes receiving a syndication feed from the syndication change server via a user computer device; and updating the firmware, software, configuration, bookmarks, and/or settings of the device.

### FIELD OF THE INVENTION

The present invention relates to a method of transmitting information via syndication services. Specifically, it relates to transmitting update information to a printer, scanner, fax, multifunction printing device, or other printing device via syndication services such as RSS 2.0 or other syndication service from a user computer device. Update information may be firmware, software, device settings, configuration information, web bookmarks, or similar information.

### BACKGROUND OF THE INVENTION

The setting of the present invention is a network (wired, wireless, or both) of devices such as printers, scanners, fax machines, multifunction printing devices, user computer devices, and handheld user computer devices. User computer devices connected to a network often need the ability to update various aspects of printing devices such as firmware, user settings, security settings, web bookmarks. These elements often change without a fixed schedule. Traditionally, these changes are “pushed” to each device by a user administrator using custom applications, scripts, or other proprietary methods.

Over time, most electronic devices, including printing devices, may need updating to improve functionality, efficiency, security, speed, compatibility, or other desired attributes. Many of these attributes are user changeable to accommodate a user's desire to improve these devices. Many times, a user changes these attributes through user settings or device firmware. Traditionally, an administrator sets the attributes on a device to a new setting each time a change is desired or required. In a large organization, dozens, if not hundreds, of printing devices may require attribute changes. In such a case, the administrator either physically walks to each printing device to complete an update or connects electronically to each printing device individually to complete an update. These traditional methods may be inefficient, time-consuming and costly.

### SUMMARY OF THE INVENTION

The present invention addresses the need for a more efficient and standardized method of transmitting update information to various printing devices. Therefore, the present invention provides a mechanism for devices to subscribe to a syndication change server using a standard syndication service protocol.

The present invention further addresses this need by providing a method of updating devices by transmitting update information via standard syndication services.

It is a first aspect of the present invention to provide a computer implemented method of updating a device via syndication services that includes receving a syndication feed from a syndication change server, and updating at least one of firmware, software, configuration, bookmarks, and settings of the device. In some embodiments, the device subscribes to the syndication feed published by the syndication change server.

In a more detailed embodiment of the first aspect of the present invention, the receiving occurs as a result of the syndication feed being altered or updated. In other detailed embodiments of this aspect, the updating includes executing computer-readable commands from the syndication feed. In some other embodiments of this aspect, the updating includes at least one of opening and executing a file attachment associated with the syndication feed. Further, in some embodiments of this aspect, the updating includes at least one of opening and executing a Uniform Resource Locator (URL).

In still yet another detailed embodiment of the first aspect of the present invention, the syndication feed is at least one of an Extensible Markup Language and XML computer-readable file. An exemplary embodiment of the first aspect provides that the syndication feed complies with the Really Simple Syndication protocol specification. Furthermore, the syndicated change server may be a software application operating on the user computer device in many embodiments of the first aspect of the present invention.

It is a second aspect of the present invention to provide a computer implemented method of updating a device via syndication services that includes receiving at a syndication change server update information from a user computer device; transmitting the update information from the syndication change server to a device for processing. Processing the update information then causes the device to update firmware, software, configuration, bookmarks, and/or settings of device.

In another embodiment of the second aspect, prior to transmitting the update information from the syndication change server to the device, the device is notified that update information is available. In yet another embodiment of the second aspect, prior to transmitting the update information from the syndication change server to the device, the syndication change server receives a query from the device for update information. In some embodiments, the query is received at a pre-determined timed interval.

In a more detailed embodiment of the second aspect of the present invention, the processing includes executing computer-readable commands from the update information.

It is a third aspect of the present invention to utilize syndication services at a printing device by receiving a syndication feed from a syndication change server and processing the syndication feed. The syndication feed is one of a print job and a software application. In another embodiment of the third aspect, the processing includes printing the print job. In yet another embodiment of the third aspect, the processing includes installing the software application on the device. In still another embodiment of the third aspect of the present invention, the processing includes executing the software application.

From the foregoing disclosure and the following detailed description of various preferred embodiments it will be apparent to those skilled in the art that the present invention provides a significant advance in the art of transmitting update information via syndication services. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a flow diagram of one embodiment of the present invention.

FIG. 2 is a flow diagram of one embodiment of the present invention.

FIG. 3 is a view of an exemplary hardware and software environment utilized in one embodiment of the present invention.

FIG. 4 is a view of an exemplary hardware and software environment utilized in one embodiment of the present invention.

FIG. 5 is a view of an exemplary hardware and software environment utilized in one embodiment of the present invention.

### DETAILED DESCRIPTION OF THE DRAWINGS

It will be apparent to those skilled in the art that many uses and variations are possible for the methods of transmitting update information via syndication services. The following detailed discussion of various alternative and preferred embodiments will illustrate the general principles of the present invention. Other embodiments will be apparent to those skilled in the art given the benefit of this disclosure.

The present invention generally relates to a method of updating a printing device via syndication services. Some examples of printing devices include printers, scanners, fax machines, multifunction devices, and other printing devices. Some examples of user computer devices include computer servers, personal computers, desktop computers, laptop computers, handheld computers, personal digital assistants, cellular telephones, and other user computer devices. Various embodiments may utilize a plurality of printing devices or a plurality of user computer devices.

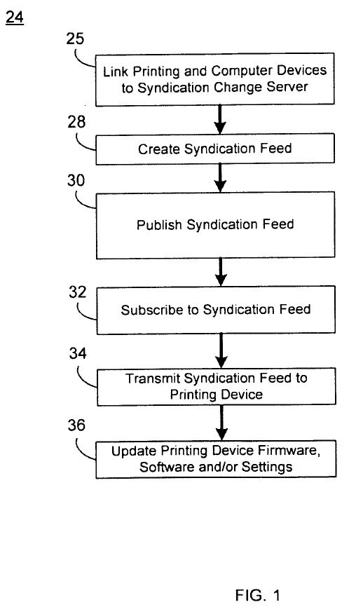

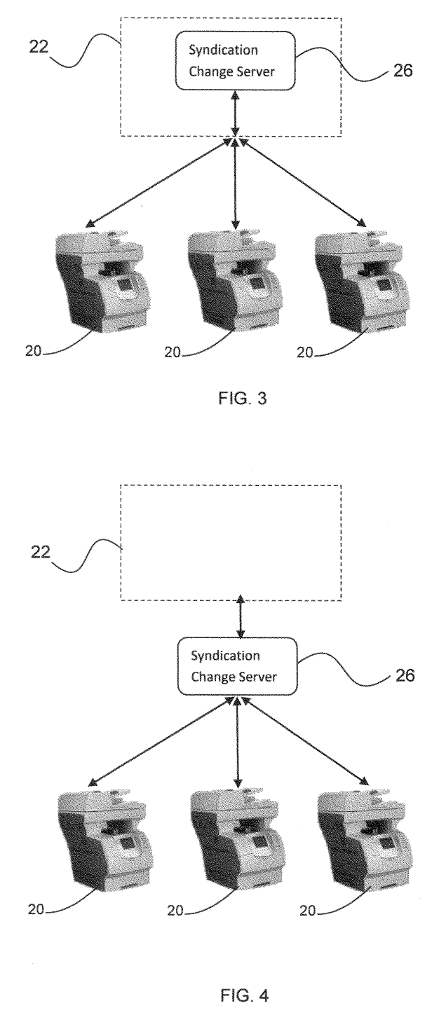

FIG. 1 depicts a flow diagram of one embodiment of the present invention. In this embodiment, a computer implemented method of updating a printing device 20 (shown in FIG. 3) via syndication services is provided 24. This method first teaches linking at least one printing device 20 and a user computer device 22 (block 25) via one or more data links to a syndication change server 26 (shown in FIG. 3). The syndication feeds are or may include computer-readable files complying with a syndication protocol including update information associated with the at least one printing device 20. Then, at block 28, a syndication feed is created on the syndication change server 26 via the user computer device 22. The syndication feed is then published (block 30), allowing the at least one printing device 20 to subscribe to the syndication feed. The at least one printing device 20 then subscribes to the syndication feed at block 32. Subsequently, the syndication feed is transmitted from the syndication change server 26 to the at least one printing device 20 (block 34). After transmission, the syndication feed is processed 36 by the at least one printing device 20 at block 36. This processing causes the at least one printing device 20 to update firmware, software, and/or settings of the at least one printing device 20. It will be appreciated by one of ordinary skill in the art that the at least one printing device 20 may subscribe to one or more syndication services.

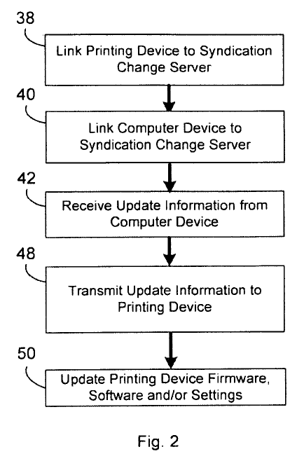

FIG. 2 also depicts a flow diagram of one embodiment of the present invention. This embodiment first teaches linking the at least one printing device 20 to the syndication change server 26 via one or more data links (block 38). The user computer device 22 is also linked via one or more data links to the syndication change server 26 (block 40). At block 42, update information from the user computer device 22 is then transmitted to the syndication change server 26. Update information includes at least one of printing device 20 firmware, software, configuration, bookmarks, and settings update information. Update information may be in any format recognized by printing device 20 and capable of being transmitted by syndication change server 26. For example, user information may be a flash file, universal configuration file, network printing alliance protocol or other proprietary format, such as .pdf. Next, at block 48, the update information is transmitted from the syndication change server 26 to the at least one printing device 20. Finally, the update information is processed by the at least one printing device 20 at block 50. This processing of the update information then includes updating firmware, software, configuration, bookmarks, and/or settings of the at least one printing device 20.

In other embodiments, additional functions, features or elements may be added to method as depicted in FIG. 2. The following functions may be alternatively incorporated, or these functions may both occur in the same embodiment. These functions include (a) notifying the at least one printing device 20 that update information is available and (b) querying the syndication change server 26 by the at least one printing device 20 for update information. The notifying function is performed by the syndication change server 26. The querying function is performed by the printing device 20. Both the notifying element and querying element may be implemented in the same environment. However, some embodiments may include either the notifying element or the querying element.

In another embodiment, syndication services may be used to provide software applications to printing device 20. For example, the syndication feed may be a software application, which when processed by printing device 20, becomes installed or embedded on printing device 20. Similar to updating printing device 20, the syndication feed may also be used to provide updates or changes to a software application.

In yet other embodiments, syndication services can be used in performing other functions at the printing device 20. For example, a print job may be transmitted from user computer device 22 to printing device 20 and automatically printed. Such ability would be useful in environments where broadcasts, such as company e-mails, are typically used. For example, syndication feeds may be particularly useful in retail settings where a company's headquarters wants to broadcast new sales or provide instructions to all of its retail outlets. In this manner, the need for a retailer to access his electronic mail to receive important company announcements may be eliminated.

Data links linking various components of the embodiments of the present invention may be any known data links. For example, the data link linking the printing device 20 to the syndication change server 26 may be wired or wireless. A wired data link may include integrated circuitry within the printing device 20, a USB data link, Firewire data link, or other similar data link. A wireless data link may include a Wi-Fi data link, WiMax data link, wireless USB data link, Bluetooth data link, or other similar data link. In another example, the data link linking the user computer device 22 to the syndication change server 26 may be a wired data link while the data link linking the syndication change server 26 to the user computer device 22 may be wireless.

The syndication change server 26 may be incorporated within the user computer device 22 by a software application. In other embodiments, the syndication change server 26 may be located external to the printing device 20. In some embodiments, the syndicated change server 26 resides on a user computer device 22 administered by the manufacturer of the printing device 20. Functions of the syndication change server 26 include notifying printing devices 20 when new syndication feeds or update information is available, receiving update information, and transmitting update information.

The syndication change server 26 may be a software application, a software application extension, or a web-based utility. The syndication change server 26 operates on the user computer device 22 or other device. Additionally, the syndication change server 26 may be implemented to display the device status information in web-based portals, internet browser applications, email applications, or blog editors. In an exemplary embodiment, the syndication change server 26 implements the Really Simple Syndication syndication protocol, such as RSS 2.0. However, any other syndication protocol format may be utilized in the present invention so long as the format is capable of supporting attachments, as is known in the art.

In some embodiments, each printing device 20 has the software and associated circuitry for accessing device information such as firmware, software, and/or settings information. This device information may include revision data, version data, and/or date of last update data. This data may be needed to determine if the printing device 20 needs the update information from the syndication change server 26. For example, if printer A has firmware version 1.5 and the syndication change server 26 has version 1.7 available, printer A can compare these versions. Printer A will then proceed to initiate, receive, and process this version update. If printer B has firmware version 1.7 and the syndication change server 26 has version 1.7 available, printer B has the most current version update and knows not to initiate transmission of the update. The capability of a printing device 20 to access update information and/or device information may be a native capability of the printing device's 20 firmware. Alternately, this capability may be an add-on feature through the use of a software application.

In one embodiment, printing devices 20 may be pre-configured by the manufacturer or retailer to access or subscribe to update information or a syndication feed located on a central server. For example, a printer 20 manufactured by Lexmark International, Inc. and sold by Dell Inc. may be pre-configured through firmware or software to access update information or a syndication feed located on servers owned and/or maintained by Lexmark International, Inc. Additionally, Dell Inc. may also pre-configure these printers 20 through firmware or software to access update information or a syndication feed located on servers owned and/or maintained by Dell Inc.

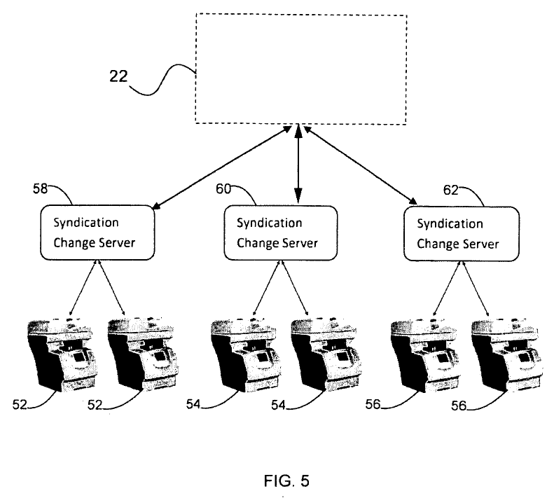

FIGS. 3, 4, and 5 depict views of exemplary hardware and software environments utilized in various embodiments of the present invention. FIG. 3 shows an environment in which the syndication change server 26 is operating within the user computer device 22. FIG. 4 shows an environment in which the syndication change server 26 is located between the user computer device 22 and the printing devices 20. FIG. 5 shows an environment in which multiple printing devices 52, 54, 56 communicate with multiple syndication change servers 58, 60, 62. Each of these environments may be utilized in various embodiments of the present invention.

The environment shown in FIG. 3 includes a user computer device 22, a syndication change server 26, and a plurality of printing devices 20. The user computer device 22 includes the syndication change server 26 operating as a software application thereon. In this embodiment, one or more printing devices 20 may communicate with the syndication change server 26 via the user computer device 22. The syndication change server 26 in this embodiment allows a user or administrator to create, publish, and/or place syndication feeds or update information. All transmission of syndication feeds or update information to the printing devices 20 in this embodiment occurs by way of the user computer device 22.

The environment shown in FIG. 4 also includes a user computer device 22, a syndication change server 26, and a plurality of printing devices 20. The syndication change server 26 in this embodiment operates independently of the user computer device 22. The syndication change server 26 in this embodiment may be operating on another device. In this embodiment, one or more printing devices 20 may communicate with the syndication change server 26 via the data links without a need to communicate using the user computer device 22. The syndication change server 26 in this embodiment also allows a user or administrator to create, publish, and/or place syndication feeds or update information. All transmission of syndication feeds or update information to the printing devices 20 in this embodiment occurs directly from the syndication change server 26.

The environment shown in FIG. 5 includes a user computer device 22, a plurality of syndication change servers 58, 60, 62, and a plurality of printing devices 52, 54, 56. Each syndication change server 58, 60, 62 in this embodiment operates independently of the user computer device 22. The syndication change servers 58, 60, 62 in this embodiment may be operating on separate devices or on the same device. In this embodiment, one or more printing devices 58, 60, 62 may communicate with its respective syndication change server 58, 60, 62 via the data links without a need to communicate using the user computer device 22. The syndication change servers 58, 60, 62 in this embodiment also allow a user or administrator to create, publish, and/or place syndication feeds or update information. All transmission of syndication feeds or update information to the printing devices 52, 54, 56 in this embodiment occurs directly from the syndication change servers 58, 60, 62.

The environment of FIG. 5 may operate like the following example. Printing devices 52, 54, and 56 may be different types of printing devices with different model numbers, features and/or functions. For example, printing devices 52 may be monochrome laser printers, printing devices 54 may be color laser printers and printing devices 56 may be multifunction inkjet printers. Therefore, printing devices 52, 54, 56 each require different firmware to update security settings. The administrator sets up syndication change server 58 to include update information for printing devices 52. The administrator sets up syndication change server 60 to include update information for printing devices 54. The administrator sets up syndication change server 62 to include update information for printing devices 56. If this example is extended such that there are 100 printing devices like printing devices 52, 100 printing devices like printing devices 54, and 100 printing devices like printing devices 56, it is easy to see the time, effort, and cost savings by implementing the present invention. Instead of updating 300 printing devices manually, the administrator only needs to update three syndication change servers 26. In other embodiments, there may be only one syndication change server 26 that includes syndication feeds or update information for a plurality of printer types or models.

Following from the above description and present invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the present invention as defined by the claims. Likewise, it is to be understood that the present invention is defined by the claims and it is not necessary to meet any or all of the identified advantages or objects of the present invention disclosed herein in order to fall within the scope of the claims, since inherent and/or unforeseen advantages of the present invention may exist even though they may not have been explicitly discussed herein.

What is claimed is:

1. A method of updating a device via syndication services, comprising:
receiving a syndication feed from a syndication change server; and
updating at least one of firmware, software, configuration, bookmarks, and settings of the device.

2. The method of claim 1, further comprising:
subscribing to the syndication feed published by the syndication change server.

3. The method claim 1, wherein the receiving occurs at a pre-determined timed interval.

4. The method of claim 1, wherein the receiving occurs as a result of the syndication feed being altered.

5. The of claim 1, wherein the updating includes executing computer-readable commands from the syndication feed.

6. The method of claim 1, wherein the updating includes at least one of opening and executing a file attachment associated with the syndication feed.

7. The method of claim 1, wherein the updating includes at least one of opening and executing a Uniform Resource Locator (URL).

8. The method of of claim 1, wherein the syndication feed is at least one of an Extensible Markup Language and XML computer-readable file.

9. The method of claim 1, wherein the syndication feed complies with the Really Simple Syndication protocol specification.

10. The method of claim 1, wherein the syndicated change server is a software application operating on a user computer device.

11. The method of claim 1, wherein the syndicated change server resides on a user computer device administered by a manufacturer of the printing device.

12. The method of claim 1, wherein the updating includes installing the software application on the device.

13. The method of claim 1, wherein the updating includes executing the software.

14. A method of updating a device via syndication services, comprising:
receiving at a syndication change server update information from a user computer device;
transmitting the update information from the syndication change server to a device for processing;
whereby the processing causes the device to update at least one of firmware, software, configuration, bookmarks, and settings of the device.

15. The method of claim 14, further comprising:
notifying the device that update information is available prior to the transmitting of the update information.

16. The method of claim 14, further comprising:
receiving at the syndication change server a query from the device for update information prior to the transmitting of the update information to the device.

17. The method of claim 14, wherein the querying occurs at a pre-determined timed interval.

18. The method of claim 14, wherein the processing includes executing computer-readable commands from the update information.

19. A method of printing at a printing device via syndication services, comprising:
receiving a syndication feed from a syndication change server; and
printing the syndication feed.

20. The method of claim 19, wherein the syndication feed is in .pdf format.
